(19) United States
(12) Patent Application Publication
(10) Pub. No.: US 2011/0070484 A1
(43) Pub. Date: Mar. 24, 2011

(54) LITHIUM PRIMARY BATTERY

(76) Inventor: Yoko SANO, Osaka (JP)

(21) Appl. No.: 12/888,945

(22) Filed: Sep. 23, 2010

(30) Foreign Application Priority Data
Sep. 24, 2009 (JP) 2009-219004

(51) Int. Cl. H01M 6/16

(52) U.S. Cl. 429/188

(57) ABSTRACT

A lithium primary battery includes: a negative electrode comprising lithium metal or a lithium alloy; a positive electrode including a positive electrode active material; a separator disposed between the negative electrode and the positive electrode; a carbon layer interposed between the negative electrode and the separator, the carbon layer including carbon particles and a coating on a surface of the carbon particles, the coating including a lithium carboxylate and lithium carbonate; and a non-aqueous electrolyte with a carboxylic acid concentration of 0% by weight or more and less than 0.01% by weight.

### FIELD OF THE INVENTION

The invention relates to a lithium primary battery, and particularly, to an improvement in the large-current discharge characteristics of a lithium primary battery in a low temperature environment in the initial state and after storage at a high temperature.

### BACKGROUND OF THE INVENTION

Lithium primary batteries have high electromotive force and high energy density. They are thus widely used as the main power source or memory back-up power source for electronic devices, such as portable appliances and in-car electronic devices. Lithium primary batteries include a negative electrode comprising lithium metal or a lithium alloy, a positive electrode, a separator, and a non-aqueous electrolyte.

Examples of positive electrode active materials used therein include metal oxides such as manganese dioxide and copper oxide, and fluorinated graphite. Manganese dioxide is widely used since it is readily available. Fluorinated graphite is superior to metal oxides such as manganese dioxide in long-term storage characteristics and stability in a high-temperature environment. The use of fluorinated graphite allows a lithium primary battery to be used in a wide temperature range.

With electronic devices becoming increasingly smaller and more light-weight and having higher performance, lithium primary batteries are also required to provide higher battery performance. Conventional lithium primary batteries are mainly used in the temperature range of approximately −20° C. to 60° C. However, when lithium primary batteries are used as the main power source and memory back-up power source for in-car electronic devices, they are required to exhibit sufficient discharge characteristics in the wide temperature range from a low temperature of approximately −40° C. to a high temperature of approximately 125° C.

Lithium primary batteries exhibit discharge behavior of a voltage drop in the initial stage of discharge followed by a gradual voltage rise. The larger the voltage drop in the initial stage of discharge, the lower the battery performance. Such discharge behavior becomes evident at low temperatures and during discharge at a large current. To improve discharge characteristics, attempts have been made to reduce the resistance of the negative electrode surface.

When the negative electrode surface is activated by reducing the resistance, the discharge characteristics improve. However, after storage at a high temperature, the discharge characteristics deteriorate significantly, because the activation of the negative electrode surface promotes the reaction between the non-aqueous electrolyte and the negative electrode during high temperature storage. The products of this reaction deposited on the negative electrode surface serve as resistance components. That is, the improvement of the discharge characteristics by modification of the negative electrode surface is highly likely to cause deterioration in storage characteristics. It is therefore very difficult to improve both discharge characteristics and storage characteristics at the same time.

Document 1 (Japanese Laid-Open Patent Publication No. Sho 50-145817) proposes a battery including a negative electrode that uses a light metal as an active material, a positive electrode, and a non-aqueous electrolyte, wherein carbon particles are pressed to the negative electrode surface. In Document 1, carbon particles are pressed thereto such that they thinly cover the negative electrode surface to form a carbon layer. Document 1 states that the formation of the carbon layer suppresses the reaction between the negative electrode and the non-aqueous electrolyte, thereby preventing deposition of reaction products on the negative electrode surface.

### BRIEF SUMMARY OF THE INVENTION

Since the carbon layer of the battery of Document 1 is composed of the carbon particles, the carbon layer tends to react with the non-aqueous electrolyte during storage at a high temperature. Thus, deposition of reaction products on the negative electrode surface may not be sufficiently suppressed. That is, according to the proposal of Document 1, it is difficult to improve discharge characteristics after high temperature storage, in particular, large-current discharge characteristics in a low temperature environment.

It is therefore an object of the invention to provide a lithium primary battery with improved large-current discharge characteristics in a low temperature environment in the initial state and after high temperature storage.

The invention provides a lithium primary battery including: a negative electrode comprising lithium metal or a lithium alloy; a positive electrode including a positive electrode active material; a separator disposed between the negative electrode and the positive electrode; a carbon layer interposed between the negative electrode and the separator, the carbon layer including carbon particles and a coating on a surface of the carbon particles, the coating including a lithium carboxylate and lithium carbonate; and a non-aqueous electrolyte with a carboxylic acid concentration of 0% by weight or more and less than 0.01% by weight.

The invention reduces the resistance components and suppresses the reduction reaction of the non-aqueous electrolyte on the negative electrode surface during battery storage at a high temperature. Therefore, the invention can provide a lithium primary battery which exhibits good large-current discharge characteristics in the initial state and after high temperature storage even in a low temperature environment.

While the novel features of the invention are set forth particularly in the appended claims, the invention, both as to organization and content, will be better understood and appreciated, along with other objects and features thereof, from the following detailed description taken in conjunction with the drawings.

### BRIEF DESCRIPTION OF THE SEVERAL VIEWS OF THE DRAWING

FIG. 1 is a longitudinal sectional view schematically showing the structure of a coin-shaped lithium primary battery according to an embodiment of the invention;

FIG. 2 shows C1s peaks in the XPS spectra of the surface of the carbon layer of Example 1;

FIG. 3 shows C1s peaks in the XPS spectra of the surface of the lithium metal of Example 1;

FIG. 4 shows C1s peaks in the XPS spectra of the surface of the lithium metal of Comparative Example 3; and

FIG. 5 shows C1s peaks in the XPS spectra of the surface of the lithium metal of Example 6.

### DETAILED DESCRIPTION OF THE INVENTION

The lithium primary battery of the invention includes a negative electrode, a positive electrode, a separator, a non-aqueous electrolyte, and a carbon layer interposed between the negative electrode and the separator. The carbon layer includes carbon particles and a coating on the surface of the carbon particles, and the coating includes a lithium carboxylate and lithium carbonate. The carbon layer is preferably formed on the negative electrode surface.

The carbon layer increases the reaction area of the negative electrode, while functioning as a lithium ion release site. That is, a part of the lithium is absorbed by the carbon particles. Since the carbon layer increases the reaction area of the negative electrode surface, it can suppress an increase in polarization upon discharge at a large current. Also, the carbon layer suppresses the reaction between the lithium metal or lithium alloy and the non-aqueous electrolyte.

The coating formed on the surface of the carbon particles suppresses the reaction between the carbon particles and the non-aqueous electrolyte. By forming the carbon layer including the coating on the negative electrode surface, it is possible to sufficiently suppress not only the reaction between the lithium metal or lithium alloy and the non-aqueous electrolyte but also the reaction between the carbon particles and the non-aqueous electrolyte. As a result, deposition of reaction products on the negative electrode surface is significantly suppressed, and an increase in resistance components on the negative electrode surface can be suppressed. Such a lithium primary battery has good pulse discharge characteristics, since an increase in polarization can be suppressed.

The coating includes a lithium carboxylate and lithium carbonate.

The lithium carboxylate in the coating is produced by the reaction between a carboxylic acid and the lithium of the negative electrode or the lithium absorbed by the carbon particles. A carboxylic acid can be brought into contact with the carbon particles by various methods.

The lithium carbonate is produced by the reaction between carbon dioxide or a component of the non-aqueous electrolyte (e.g., propylene carbonate) and the lithium of the negative electrode or the lithium absorbed by the carbon particles. Carbon dioxide enters the battery in the production process of the battery.

The coating is formed on at least the surface of the carbon particles, and the coating may be further formed on the surface of the lithium metal or lithium alloy.

The coating including the lithium carboxylate and the lithium carbonate, which is relatively porous, is unlikely to interfere with Li ion transfer and does not serve as a large resistance component even at low temperatures. Hence, the release of ions from the surface of the lithium metal or lithium alloy is hardly impeded. Also, since the coating is porous as described above, it does not impede the carbon layer's functions of increasing the reaction area of the negative electrode and providing a lithium ion release site.

Since the coating including the lithium carboxylate and the lithium carbonate has a high decomposition temperature and low reactivity with solvents, it is stable even at high temperatures. Generally, when a battery is stored at a high temperature, the reaction between the negative electrode and the non-aqueous electrolyte proceeds easily. However, since the coating including the lithium carboxylate and the lithium carbonate is stable even at high temperatures, the reaction between the negative electrode and the non-aqueous electrolyte can be significantly suppressed.

The non-aqueous electrolyte has a carboxylic acid concentration of 0% by weight or more and less than 0.01% by weight. That is, the non-aqueous electrolyte is almost free of a carboxylic acid. When the carboxylic acid concentration in the non-aqueous electrolyte is 0% by weight or more and less than 0.01% by weight, the amount of the coating is optimized and the resistance becomes low, so the stability of the coating improves.

As described above, by forming the carbon layer including the coating on the negative electrode surface, the resistance of the negative electrode can be significantly reduced. It is therefore possible to obtain a lithium primary battery which exhibits good large-current discharge characteristics even in a low temperature environment. Also, the lithium primary battery according to this embodiment exhibits good large-current discharge characteristics even after storage at a high temperature. Lithium primary batteries for use as the main power source and memory back-up power source for in-car electronic devices are required to provide good characteristics at a low temperature of −40° C. and after storage at a high temperature of 125° C. In such a harsh environment, the coating produces a remarkable effect in improving discharge characteristics. Also, the reaction area of the negative electrodes of lithium primary batteries is inherently small. Thus, the effect of the coating on reactivity becomes more evident.

The coating is formed on the surface of the carbon particles. Forming the coating on the surface of the carbon particles increases the contact area of the coating and the non-aqueous electrolyte, thereby increasing the effect of suppressing an increase in resistance. That is, it is possible to suppress an increase in resistance significantly, compared with a coating formed directly on the surface of the lithium metal or lithium alloy.

The lithium carboxylate and lithium carbonate contained in the coating can be identified by XPS. In the XPS spectrum of the coating, the ratio (area ratio) of the peak attributed to the lithium carboxylate to the peak attributed to the lithium carbonate is preferably 0.4 or more and less than 25.

By bringing a suitable amount of a carboxylic acid into contact with the surface of the carbon particles, a coating with such a peak ratio can be obtained.

The XPS of the coating is performed using, for example, an X-ray photoelectron spectrometer (trade name: Model 5600, ULVAC-PHI Inc.). The coating is irradiated with an argon beam in the spectrometer, and a change in the C1s or O1s spectra with irradiation time is measured. The spectra can be measured, for example, in the range from the outermost surface of the coating to a depth of approximately 10 nm (preferably a depth of 0.9 to 3.1 nm). In order to avoid analysis errors, it is preferable not to consider the spectrum of electrons on the outermost surface. For example, in the C1s spectrum, peaks attributed to the lithium carboxylate and lithium carbonate can be identified around 290 to 289 eV. In the O1s spectrum, peaks attributed to the lithium carboxylate and lithium carbonate can be identified around 533 to 530 eV.

From the change in the XPS spectra, atomic concentration (%) (component ratio) can be calculated. First, the peaks around 290 to 289 eV in the C1s spectrum are separated into the peak attributed to the lithium carbonate (around 290 eV) and the peak attributed to the lithium carboxylate (around 289 eV). From the ratio of these peaks, the component ratio of the lithium carboxylate to the lithium carbonate can be obtained.

Although the detailed reasons are not clear, when the coating contains a large amount of lithium carbonate, the coating tends to become relatively porous. When the coating contains a large amount of a lithium carboxylate, the coating tends to become relatively dense. If the peak ratio is less than 0.4, the amount of lithium carboxylate contained in the coating is thought to be too small. In this case, the coating tends to become too porous. If the coating is too porous, the effect of suppressing the reaction between the carbon layer and the non-aqueous electrolyte during high temperature storage may become insufficient. As a result, the battery characteristics may deteriorate particularly after high temperature storage.

If the peak ratio is 25 or more, the amount of lithium carboxylate contained in the coating may become excessive. When the amount of lithium carboxylate is excessive, the coating tends to become too dense. When the coating is too dense, it may impede the release of ions from the surface of the lithium metal or lithium alloy and the carbon layer's function as a lithium ion release site. As a result, it may degrade the discharge characteristics particularly at a large current.

The ratio of the peak attributed to the lithium carboxylate to the peak attributed to the lithium carbonate is more preferably 0.4 to 6, since good large-current discharge characteristics and high-temperature storage characteristics can be obtained.

The thickness of the coating is preferably 0.9 nm or more and 30 nm or less, more preferably 2 nm or more and 20 nm or less, and even more preferably 3 nm or more and 20 nm or less. The coating of such thickness neither suppresses the reactivity of the negative electrode excessively nor activates the reactivity of the negative electrode excessively. If the coating suppresses the reactivity of the negative electrode excessively, the carbon layer's function as a lithium ion release site is suppressed, so the improvement of the discharge characteristics may become insufficient. If the coating activates the reactivity of the negative electrode excessively, the discharge characteristics are improved, but the reduction reaction of the non-aqueous electrolyte is promoted, so the high-temperature storage characteristics may deteriorate. The thickness of the coating can be estimated, for example, by XPS. Specifically, the thickness of the coating is estimated from a depth up to which the peaks attributed to the coating are stably observed. For example, when the peaks attributed to the coating are stably observed up to 3.1 nm, the thickness of the coating can be estimated to be 3.1 nm or more.

By bringing a suitable amount of a carboxylic acid into contact with the surface of the carbon particles, a coating of such thickness can be formed.

It is preferable to use carbon black or graphite as the carbon particles. Carbon black has a good conductivity. Also, carbon black has a small primary particle size. Thus, carbon black has pores suitable for holding the non-aqueous electrolyte and easily forms an even carbon layer.

Examples of carbon blacks include acetylene black, ketjen black, contact black, furnace black, and lamp black. These carbon blacks can be used singly or in combination. The mean size of primary particles of the carbon black is preferably 35 to 40 nm.

Graphite also has a good conductivity just like carbon black. Examples of graphites include artificial graphites and natural graphites. Artificial graphites include high purity graphite and high crystalline graphite. These graphites can be used singly or in combination. The mean particle size of the graphite is preferably 0.1 to 10 μm.

As described above, since carbon black and graphite have a good conductivity, they are preferable as carbon particles. On the other hand, the use of a carbon material with a low conductivity may increase the polarization of the negative electrode during discharge.

For the carbon particles, for example, one or more carbon blacks and one or more graphites can be used in combination. Various commercially available carbon blacks and graphites can be used. An example of acetylene black is DENKA BLACK (trade name) (mean primary particle size: 35 nm, specific surface area: 68 m²/g) available from Denki Kagaku Kogyo K.K. An example of ketjen black is carbon ECP (trade name) (specific surface area: 800 m²/g) available from Lion Corporation. An example of graphite is CARBOTRON PS(F) (trade name) (mean particle size: approximately 10 μm, specific surface area: 6.1 m²/g) available from Kureha Corporation.

While the thickness of the carbon layer is not particularly limited, it is preferably 0.2 to 10 μm, and more preferably 0.5 to 5 μm.

In forming the carbon layer, the amount of carbon particles disposed per unit area, rather than the thickness of the carbon layer, may be controlled. The carbon layer can be formed on at least a part of the surface of the negative electrode facing the positive electrode. Preferably, the carbon layer is formed on the whole surface of the negative electrode facing the positive electrode. When the carbon layer is formed on the surface of the negative electrode facing the positive electrode in such a manner that the amount of carbon particles is 0.2 to 2 mg per square centimeter, the carbon layer can sufficiently perform the functions of increasing the reaction area of the negative electrode and providing a lithium ion release site. It is also possible to sufficiently suppress the reaction between the lithium metal or lithium alloy and the non-aqueous electrolyte.

If the amount of carbon particles on the surface of the negative electrode facing the positive electrode is less than 0.2 mg per square centimeter, the functions of the carbon layer may become insufficient. If the amount of carbon particles on the surface of the negative electrode facing the positive electrode is larger than 2 mg per square centimeter, the amount of electrolyte absorbed by the carbon layer may become excessive. Thus, the amount of non-aqueous electrolyte required to obtain sufficient battery characteristics may become too large, thereby resulting in a relative decrease in the amounts of the positive electrode and the negative electrode inside the battery and a decrease in battery capacity.

The amount of carbon particles can be determined by removing the carbon layer from the negative electrode, drying the removed carbon layer, and measuring the weight. Although the removed carbon layer may contain absorbed Li, the coating, and the like, their amounts are very small, compared with the amount of carbon particles. As such, the measured weight can be regarded as the amount of carbon particles.

The lithium carboxylate contained in the coating is represented by the general formula: R—COOLi where R is H or CₙH₂ₙ₊₁ where 1≦n≦3. When R is CₙH₂ₙ₊₁ where 1≦n≦3, the coating on the negative electrode surface becomes particularly stable. These lithium carboxylates can be used singly or in combination.

The negative electrode with the carbon layer can be obtained, for example, by applying a dispersion containing carbon particles and a carboxylic acid onto the surface of lithium metal or a lithium alloy. Specifically, first, a dispersion is prepared by dispersing carbon particles in a low boiling-point solvent. A carboxylic acid is then added to the dispersion. The amount of carboxylic acid added is preferably 0.01 to 5% by weight of the solvent, and more preferably 0.05 to 3% by weight. If the amount of carboxylic acid added to the dispersion is less than 0.01% by weight of the solvent, the coating formed on the surface of the carbon particles may become insufficient. If the amount of carboxylic acid added to the dispersion containing the carbon particles exceeds 5% by weight, drying the solvent may require a long time or high temperature, thereby causing a decrease in battery productivity, because a carboxylic acid has a relatively high boiling point.

Thereafter, the dispersion containing the carbon particles and carboxylic acid is applied onto the surface of the lithium metal or lithium alloy. When the dispersion is applied, the carbon particles adhere to the surface of the lithium metal or lithium alloy, and the carboxylic acid comes into contact with the surface of the carbon particles and the surface of the negative electrode. As a result, a coating containing a lithium carboxylate and lithium carbonate is formed on the surface of the carbon particles and the surface of the negative electrode.

It is preferable to dry the surface of the lithium metal or lithium alloy with the carbon particles to volatilize the solvent, and then press the surface with the carbon particles by means of a hydraulic press or the like while applying ultrasonic vibrations to the carbon particles. According to this method, an even carbon layer is easily formed on the surface of the lithium metal or lithium alloy.

Alternatively, it is also possible to attach carbon particles to the surface of lithium metal or a lithium alloy and then bring a carboxylic acid into contact with the surface with the carbon particles. For example, a suitable amount of a carboxylic acid can be added to a non-aqueous electrolyte, and the non-aqueous electrolyte can be brought into contact with the surface with the carbon particles. In this case, in the battery production process, the carboxylic acid contained in the non-aqueous electrolyte reacts with the negative electrode to form a coating containing a lithium carboxylate and lithium carbonate. The carboxylic acid reacts with the negative electrode more easily than the other components contained in the non-aqueous electrolyte. Thus, a good coating can be promptly formed on the surface of the carbon particles.

The method of attaching carbon particles to the surface of lithium metal or a lithium alloy is not particularly limited. Such examples include a method using a pressing tool and a method using a roller press.

According to a method using a roller press, first, a drum whose surface has an insulating property is electrified, and a layer of carbon particles with uniform thickness is formed on the surface of the drum. The carbon particle layer is transferred to the surface of lithium metal or a lithium alloy, and the transferred carbon particles are pressed to the lithium metal or lithium alloy with a roller press.

According to a method using a pressing tool, carbon particles are attached to an end face of the pressing tool, and the end face is pressed against the surface of lithium metal or a lithium alloy.

When a carboxylic acid is added to the non-aqueous electrolyte, the amount of carboxylic acid added is preferably 0.01 to 0.5% by weight of the non-aqueous electrolyte, and more preferably 0.05 to 0.5% by weight. When the amount of carboxylic acid added is set to 0.01 to 0.5% by weight, a sufficient coating can be formed on the negative electrode. In this case, the carboxylic acid added to the non-aqueous electrolyte is consumed in the formation of the coating, and the amount of carboxylic acid contained in the non-aqueous electrolyte eventually becomes less than 0.01% by weight.

The carboxylic acid is preferably a saturated carboxylic acid, and more preferably a fatty acid, which is a chain carboxylic acid. A saturated carboxylic acid is resistant to oxidation and susceptible to reduction. Thus, a saturated carboxylic acid is resistant to oxidation at the positive electrode, and is easily reduced at the negative electrode to form a good coating. Saturated dicarboxylic acids such as oxalic acid, malonic acid, and succinic acid, and unsaturated carboxylic acids are more susceptible to oxidative decomposition than saturated carboxylic acids, so they may not form a sufficient coating on the negative electrode. Carboxylic acids may be used singly or in combination.

Examples of saturated carboxylic acids include HCOOH (formic acid), CH₃COOH (acetic acid), C₂H₅COOH (propionic acid), C₃H₇COOH (butyric acid), C₄H₉COOH (valeric acid), C₅H₁₁COOH (caproic acid), and C₇H₁₃COOH (enanthic acid). They may be used singly or in combination. Among them, the use of propionic acid, butyric acid, or valeric acid is preferable. These carboxylic acids are unlikely to excessively dilute the low boiling-point solvent or the non-aqueous electrolyte dispersing the carbon particles. Butyric acid, in particular, is more preferable since it is relatively inexpensive and readily available.

A carboxylic acid with a high molecular weight is relatively expensive, and may excessively dilute the dispersion of carbon particles or the non-aqueous electrolyte. On the other hand, if the molecular weight is too low, such a carboxylic acid is highly hydrophilic, and may be difficult to handle when mixed into the non-aqueous electrolyte.

The negative electrode comprises lithium metal or a lithium alloy. Compared with lithium metal, a lithium alloy can provide improved physical properties or improved surface state. The lithium alloy can be one which is commonly used in this field, and usable examples are those which contain lithium as the matrix component and contain one or more metals alloyable with lithium. Examples of metals alloyable with lithium include aluminum, tin, magnesium, indium, calcium, and manganese. While the content of the metal(s) alloyable with lithium in the lithium alloy is not particularly limited, it is preferably 5% by weight or less of the lithium alloy. If it is more than 5% by weight, such a lithium alloy tends to have a higher melting point, become harder, and be more difficult to work.

The lithium metal or lithium alloy is worked into the desired shape and thickness depending on the shape, dimensions, spec, etc. of the finally obtained lithium primary battery. For example, it is shaped into a disc with a diameter of approximately 5 to 25 mm and a thickness of approximately 0.2 to 2 mm when the lithium primary battery is a coin battery.

The non-aqueous electrolyte contains a non-aqueous solvent and a solute dissolved therein. The non-aqueous electrolyte may contain a carboxylic acid in an amount of 0.01% by weight or less. When the non-aqueous electrolyte contains a carboxylic acid, the carboxylic acid is reduced on the negative electrode surface to form a lithium carboxylate, so that a coating containing the lithium carboxylate and lithium carbonate is formed on the surface of the carbon particles and the surface of the negative electrode. If the carboxylic acid concentration in the non-aqueous electrolyte is 0.01% by weight or more, a lithium carboxylate is formed excessively during battery storage at a high temperature, although the detailed reason is not clear. If the amount of lithium carboxylate is excessive relative to lithium carbonate, an excessively dense coating may be formed. Such coating can impede the release of ions from the surface of the lithium metal or lithium alloy and the carbon layer's function as a lithium ion release site.

The amount of carboxylic acid contained in the non-aqueous electrolyte can be measured using a high-performance liquid chromatograph (HPLC) (Alliance available from Nihon Waters Corporation).

The solute can be one commonly used in the field of lithium primary batteries. Examples include lithium hexafluorophosphate (LiPF₆), lithium perchlorate (LiClO₄), lithium tetrafluoroborate (LiBF₄), lithium trifluoromethanesulfonate (LiCF₃SO₃), lithium bis(trifluoromethylsulfonyl)imide (LiN(CF₃SO₂)₂), lithium bis(pentafluoroethylsulfonyl)imide (LiN(C₂F₅SO₂)₂) lithium bis(trifluoromethylsulfonyl)(pentafluoroethylsulfonyl)imide (LiN(CF₃SO₂)(C₂F₅SO₂)), and lithium tris(trifluoromethylsulfonyl)methide (LiC(CF₃SO₂)₂). These solutes can be used singly or in combination.

While the solute concentration in the non-aqueous electrolyte is not particularly limited, it is preferably 0.5 to 1.5 mol/L. If the solute concentration is less than 0.5 mol/L, characteristics at room temperature such as discharge characteristics and long-term storage characteristics may deteriorate. If the solute concentration is higher than 1.5 mol/L, particularly in a low temperature environment at approximately −40° C., the viscosity of the non-aqueous electrolyte may increase and the ion conductivity may lower.

The non-aqueous solvent can be one commonly used in the field of lithium primary batteries. Examples include propylene carbonate (PC), ethylene carbonate (EC), butylene carbonate (BC), vinylene carbonate (VC), vinyl ethylene carbonate (VEC), 1,2-dimethoxyethane (DME), 1,2-diethoxyethane (DEE), dimethyl carbonate (DMC), diethyl carbonate (DEC), ethyl methyl carbonate (EMC), N,N-dimethylformamide, tetrahydrofuran (THF), 2-methyltetrahydrofuran, dimethyl sulfoxide, formamide, acetamide, acetonitrile, propylnitrile, nitromethane, ethyl monoglyme, trimethoxymethane, dioxolane, dioxolane derivatives, sulfolane, methylsulfolane, propylene carbonate derivatives, and tetrahydrofuran derivatives. These non-aqueous solvents can be used singly or in combination.

Among them, the non-aqueous solvent preferably contains PC. Since PC has a relatively high viscosity, it is preferable to use PC and a low-viscosity solvent in combination. The low-viscosity solvent is preferably DME. The volume ratio of PC to DME is preferably from 85:15 to 50:50 (PC:DME). Also, the total weight of PC and DME is preferably 80 to 100% of the total weight of non-aqueous solvents.

The positive electrode includes, for example, a positive electrode active material, a conductive material, and a binder.

The positive electrode active material can be one commonly used in the field of lithium primary batteries. For example, metal oxides such as manganese dioxide and copper oxide and fluorinated graphite are preferable. As the metal oxide, manganese dioxide is preferable in that it is readily available and superior in discharge characteristics. Fluorinated graphite is preferable in that it is superior in long-term reliability, safety, high temperature stability, and the like. Preferable fluorinated graphite is represented by the chemical formula (CFₓ)ₙ where 0.9≦x≦1.1. Fluorinated graphite is produced by fluorinating petroleum coke, artificial graphite, or the like. In this method, a carbonaceous material (C) such as petroleum coke or artificial graphite is usually reacted with fluorine (F) in a molar ratio of 1:x to form fluorinated graphite comprising a large number (n) of CFₓ materials. These positive electrode active materials can be used singly or in combination.

The conductive material can be an electronic conductor that is chemically stable in the potential range of the positive electrode active material used during charge/discharge. Examples include graphites, carbon blacks, carbon fiber, metal fiber, and organic conductive materials. These conductive materials can be used singly or in combination. While the amount of conductive material used is not particularly limited, it is, for example, 3 to 30 parts by weight per 100 parts by weight of the positive electrode active material.

The binder can be a material chemically stable in the potential range of the positive electrode active material used during charge/discharge. Examples include fluorocarbon resin such as polyvinylidene fluoride (PVDF), styrene-butadiene rubber (SBR), fluoro rubber, and polyacrylic acid. These binders can be used singly or in combination. While the amount of binder is not particularly limited, it is, for example, 3 to 15 parts by weight per 100 parts by weight of the positive electrode active material.

The separator can be a material that is resistant to the environment inside the lithium primary battery, and examples include non-woven fabric made of resin and porous films made of resin. Examples of synthetic resins used for non-woven fabric include polypropylene (PP), polyphenylene sulfide (PPS), and polybutylene terephthalate (PBT). Among them, PPS and PBT are preferable since they have good resistance to high temperatures and solvents and good electrolyte retention. Also, resin materials used for porous films include, for example, polyethylene (PE) and polypropylene (PP).

The lithium primary battery is produced, for example, by sealing the negative electrode, the positive electrode, the separator, and the non-aqueous electrolyte in a positive electrode case and a negative electrode case with a gasket.

The positive electrode case serves as the positive electrode current collector and the positive electrode terminal. The negative electrode case serves as the negative electrode current collector and the negative electrode terminal. The positive electrode case and the negative electrode case can be those commonly used in the field of lithium primary batteries, and can be made of, for example, stainless steel.

The gasket serves to mainly insulate the positive electrode case from the negative electrode case. The gasket can be made of, for example, a synthetic resin such as polypropylene (PP), polyphenylene sulfide (PPS), or polyether ether ketone (PEEK). PPS, in particular, is preferable since it has good resistance to high temperatures and solvents and good formability.

### EXAMPLES

The invention is hereinafter described specifically by way of Examples and Comparative Examples.

### Example 1

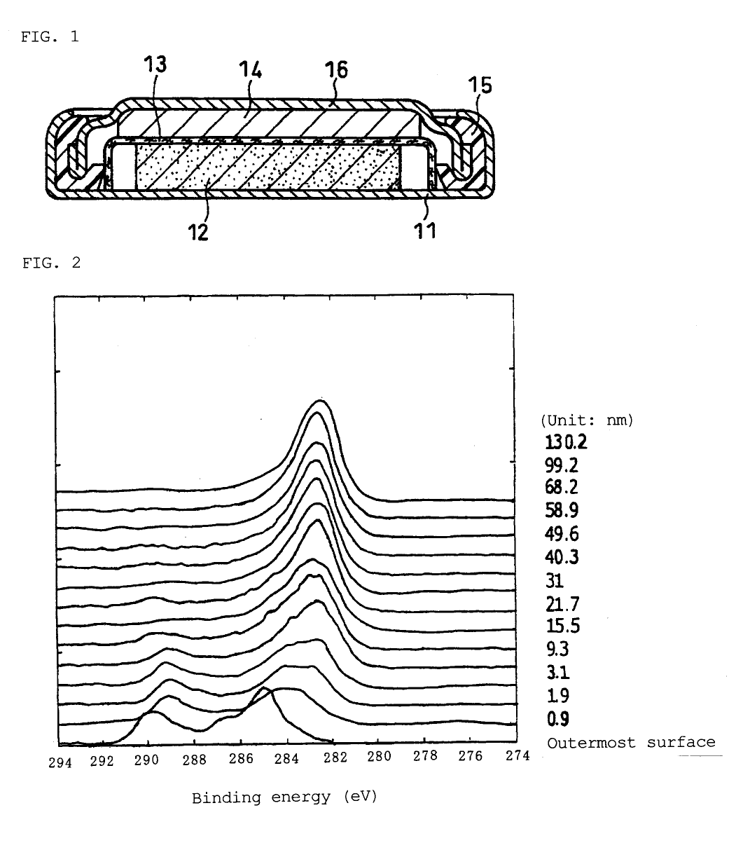

A coin-shaped lithium primary battery 1 illustrated in FIG. 1 was produced in the following procedure.

### (1) Formation of Carbon Layer on Negative Electrode

DENKA BLACK (trade name) (mean primary particle size 35 nm) available from Denki Kagaku Kogyo K.K. was used as an acetylene black powder (carbon particles). A dispersion containing carbon particles was prepared by dispersing 2 parts by weight of the acetylene black powder in 100 parts by weight of dimethoxyethane (DME). Thereafter, butyric acid in an amount of 0.5% by weight of DME was added to the dispersion.

A 1.3-mm thick lithium metal was punched into an 18.0-mm diameter disc and used as a negative electrode 14. The dispersion containing the carbon particles and butyric acid was applied onto a surface of the negative electrode 14 such that the weight of the carbon particles was 0.9 mg/cm². After the solvent was dried, the surface of the negative electrode 14 was pressed while ultrasonic vibrations were applied thereto, so that a carbon layer was formed on the negative electrode surface.

The face of the negative electrode 14 opposite to the face with the carbon layer was bonded to the inner face of a negative electrode case 16 made of stainless steel by pressure. It is noted that the carbon layer was formed on the negative electrode in dry air with a dew point of −50° C. or less.

### (2) Preparation of Positive Electrode

Manganese dioxide (MnO₂) was used as the positive electrode active material. A positive electrode mixture was prepared by mixing manganese dioxide, ketjen black (conductive material), and fluorocarbon resin (binder) in a weight ratio of 100:3:6. The fluorocarbon resin used was the solid content of Neoflon ND-1 (trade name) (tetrafluoroethylene-hexafluoropropylene copolymer (FEP)) available from Daikin Industries, Ltd. The positive electrode mixture was molded into a pellet with a diameter of 16 mm and a thickness of 3 mm, using a predetermined mold and a hydraulic press. This pellet was dried at 200° C. for 12 hours to produce a positive electrode 12.

### (3) Preparation of Non-Aqueous Electrolyte

Lithium perchlorate (LiClO₄), serving as a solute, was dissolved at a concentration of 0.5 mol/L in a solvent mixture of propylene carbonate (PC) and dimethoxyethane (DME) in a volume ratio of 1:1. Further, 1,3-propane sultone (PS) in an amount of 2% of the total weight of the solute and the solvents was added to prepare a non-aqueous electrolyte. The purpose of adding 1,3-propane sultone (PS) was to lower the reactivity of the positive electrode during high temperature storage, since the reactivity between manganese dioxide (positive electrode active material) and the non-aqueous electrolyte is very high.

### (4) Battery Fabrication

The positive electrode 12 was disposed on the inner bottom face of a stainless steel positive electrode case 11, and a separator 13 was disposed on the positive electrode 12. Subsequently, a predetermined amount of the non-aqueous electrolyte was injected therein to impregnate the positive electrode 12 and the separator 13 with the non-aqueous electrolyte. The separator 13 used was non-woven fabric made of polybutylene terephthalate (PBT).

Thereafter, the negative electrode case 16 to which the negative electrode 14 was bonded by pressure was fitted to the positive electrode case 11. The open edge of the positive electrode case 11 was crimped onto the circumference of the negative electrode case 16 with the gasket 15 therebetween, to seal the opening of the positive electrode case 11. In this way, the coin battery 1 (outer diameter 24.5 mm, thickness 5.0 mm) was produced. The fabrication of the battery was performed in dry air with a dew point of −50° C. or less.

### Example 2

A coin-shaped lithium primary battery was produced in the same manner as in Example 1, except that the dispersion containing carbon particles and butyric acid was applied onto a surface of the negative electrode such that the weight of the carbon particles was 0.2 mg/cm².

### Example 3

A coin-shaped lithium primary battery was produced in the same manner as in Example 1, except that the dispersion containing carbon particles and butyric acid was applied onto a surface of the negative electrode such that the weight of the carbon particles was 1.6 mg/cm².

### Example 4

A coin-shaped lithium primary battery was produced in the same manner as in Example 1, except that the dispersion containing carbon particles and butyric acid was applied onto a surface of the negative electrode such that the weight of the carbon particles was 2.0 mg/cm².

### Example 5

A coin-shaped lithium primary battery was produced in the same manner as in Example 1, except that butyric acid in an amount of 0.05% of the total weight of the solute and the solvents was added to the non-aqueous electrolyte, instead of adding butyric acid to the dispersion of carbon particles.

### Comparative Example 1

A coin-shaped lithium primary battery was produced in the same manner as in Example 1 except that a carbon layer was not formed on the negative electrode. Specifically, a mixture containing DME and butyric acid in the same ratio as that of the dispersion used in Example 1 but not containing carbon particles was applied onto a surface of the negative electrode.

### Comparative Example 2

A coin-shaped lithium primary battery was produced in the same manner as in Example 1, except that butyric acid was not added to the dispersion of carbon particles.

### Comparative Example 3

A coin-shaped lithium primary battery was produced in the same manner as in Example 1, except a punched lithium metal was used as the negative electrode without using carbon particles and butyric acid.

### Example 6

### (1) Formation of Carbon Layer on Negative Electrode

A carbon layer was formed on the negative electrode in the same manner as in Example 1, except that in preparing a dispersion containing carbon particles and butyric acid, butyric acid in an amount of 1% by weight of DME was added to the dispersion.

### (2) Preparation of Positive Electrode

Fluorinated graphite ((CF_{1.0})ₙ), serving as the positive electrode active material, was prepared by fluorinating petroleum coke. A positive electrode mixture was prepared by mixing the fluorinated graphite, acetylene black (conductive material), and styrene-butadiene rubber (SBR:binder) in a weight ratio of 100:15:6. The positive electrode mixture was molded into a pellet with a diameter of 16 mm and a thickness of 3 mm, using a predetermined mold and a hydraulic press. This pellet was dried at 100° C. for 12 hours to produce a positive electrode.

### (3) Preparation of Non-Aqueous Electrolyte

A non-aqueous electrolyte was prepared by dissolving lithium tetrafluoroborate (LiBF₄) (solute) at a concentration of 1.0 mol/L in a solvent mixture (PC-DME solvent) containing propylene carbonate (PC) and dimethoxyethane (DME) in a volume ratio of 1:1.

A coin-shaped lithium primary battery was produced in the same manner as in Example 1, except for the use of the negative electrode, the non-aqueous electrolyte, and the positive electrode thus prepared.

### Comparative Example 4

A coin-shaped lithium primary battery was produced in the same manner as in Example 6 except that a carbon layer was not formed on the negative electrode. Specifically, a mixture containing DME and butyric acid in the same ratio as that of the dispersion used in Example 6 but not containing carbon particles was applied onto a surface of the negative electrode.

### Comparative Example 5

A coin-shaped lithium primary battery was produced in the same manner as in Example 6, except that butyric acid was not added to the dispersion of carbon particles.

### Comparative Example 6

A coin-shaped lithium primary battery was produced in the same manner as in Example 6, except a punched lithium metal was used as the negative electrode without using carbon particles and butyric acid.

### Example 7

A coin-shaped lithium primary battery was produced in the same manner as in Example 6, except for the use of the same negative electrode as that of Example 1.

### Comparative Example 7

A coin-shaped lithium primary battery was produced in the same manner as in Example 6, except for the use of a non-aqueous electrolyte prepared by dissolving lithium tetrafluoroborate (LiBF₄) (solute) at a concentration of 1.0 mol/L in a solvent of γ-butyrolactone (GBL)

### (A) Evaluation of Static Characteristics in Initial State

Immediately after the respective batteries were produced, they were preliminarily discharged at a constant current of 4 mA for 30 minutes. Further, they were subjected to aging at 60° C. for a day. After their open circuit voltages (OCV) became stable, their OCVs and internal resistances at 1 kHz at room temperature were measured. Of each of the Examples and Comparative Examples, three batteries were evaluated, and the average of the three internal resistance values was obtained.

### (B) Evaluation of Large-Current Discharge Characteristic at Low Temperature

After the respective batteries were subjected to aging at 60° C. for a day, they were subjected to pulse discharge in a −40° C. environment to evaluate their low-temperature large-current discharge characteristic. Specifically, after they were discharged at a current of 10 mA for 20 milliseconds, they were allowed to stand for 60 seconds, and this pattern was repeated to measure a change in the voltage during pulse discharge with time. The lowest pulse voltage in 30 hours was obtained. Of each of the Examples and Comparative Examples, three batteries were evaluated, and the average of the three lowest pulse voltage values was obtained.

### (C) Evaluation of Static Characteristics After Storage at 125° C.

After the respective batteries were stored at a high temperature of 125° C. for a predetermined period, they were left at room temperature for 3 hours to measure their OCVs and internal resistances at 1 kHz. The storage period of the batteries of Examples 1 to 5 and Comparative Examples 1 to 3 was set to 24 hours, while the storage period of the batteries of Examples 6 and 7 and Comparative Examples 4 to 7 was set to 5 days. Of each of the Examples and Comparative Examples, three batteries were evaluated, and the averages of the three OCVs and internal resistance values were obtained.

### (D) Evaluation of Large-Current Discharge Characteristic at Low Temperature After Storage at 125° C.

After the respective batteries were stored at a high temperature of 125° C. for a predetermined period, they were left at room temperature for 3 hours and then subjected to pulse discharge in a −40° C. environment to evaluate their low-temperature large-current discharge characteristic. Specifically, after they were discharged at a current of 10 mA for 20 milliseconds, they were allowed to stand for 60 seconds, and this pattern was repeated to measure a change in the voltage during pulse discharge with time. The lowest pulse voltage in 30 hours was obtained. The storage period of the batteries of Examples 1 to 5 and Comparative Examples 1 to 3 was set to 24 hours, while the storage period of the batteries of Examples 6 and 7 and Comparative Examples 4 to 7 was set to 5 days. Of each of the Examples and Comparative Examples, three batteries were evaluated, and the average of the three pulse voltage values was obtained.

(i) Table 1 shows the results of (A) to (D) of Examples 1 to 5 and Comparative Examples 1 to 3, in which the positive electrode active material is manganese dioxide (MnO₂). In Table 1, “Amount of carbon particles” shows the weight of the carbon particles contained in the carbon layer per unit area. Also, “∘” shows that butyric acid was brought into contact with the negative electrode surface, while “×” shows that butyric acid was not used.

TABLE 1

| | | | | | | After 24-hour storage at | | |
|---|---|---|---|---|---|---|---|---|
| | Amount of | Contact | Initial state | | | 125° C. | | |
| | carbon | of | Voltage | Internal | Pulse | Voltage | Internal | Pulse |
| | particles | butyric | (OCV) | resistance | voltage | (OCV) | resistance | voltage |
| | (mg/cm²) | acid | (V) | (Ω) | (V) | (V) | (Ω) | (V) |
| Example 1 | 0.9 | ∘ | 3.24 | 4.7 | 2.64 | 3.27 | 17.8 | 1.80 |
| Example 2 | 0.2 | ∘ | 3.24 | 5.0 | 2.49 | 3.27 | 18.2 | 1.68 |
| Example 3 | 1.6 | ∘ | 3.24 | 4.6 | 2.63 | 3.27 | 17.8 | 1.78 |
| Example 4 | 2.0 | ∘ | 3.24 | 4.5 | 2.63 | 3.27 | 17.7 | 1.79 |
| Example 5 | 0.9 | ∘ | 3.24 | 4.8 | 2.64 | 3.27 | 17.8 | 1.80 |
| Comp. | 0 | ∘ | 3.24 | 6.3 | 2.22 | 3.27 | 29.9 | 1.48 |
| Example 1 | | | | | | | | |
| Comp. | 0.9 | x | 3.24 | 5.5 | 2.47 | 3.27 | 18.5 | 1.55 |
| Example 2 | | | | | | | | |
| Comp. | 0 | x | 3.24 | 7.1 | 2.15 | 3.28 | 46.8 | 1.19 |
| Example 3 | | | | | | | | |

(ii) Table 2 shows the results of Examples 6 and 7 and Comparative Examples 4 to 7, in which the positive electrode active material is fluorinated graphite ((CF_{1.0})ₙ). In Table 2, “Amount of carbon particles” shows the weight of the carbon particles contained in the carbon layer per unit area. Also, “∘” shows that butyric acid was brought into contact with the negative electrode surface, while “×” shows that butyric acid was not used.

TABLE 2

| | Amount of | Contact | Initial state | | | After 5-day storage at 125° C. | | |
|---|---|---|---|---|---|---|---|---|
| | carbon | of | Voltage | Internal | Pulse | Voltage | Internal | Pulse |
| | particles | butyric | (OCV) | resistance | Voltage | (OCV) | resistance | voltage |
| | (mg/cm²) | acid | (V) | (Ω) | (V) | (V) | (Ω) | (V) |
| Example 6 | 0.9 | ∘ | 3.31 | 7.1 | 1.76 | 3.39 | 22.5 | 1.34 |
| Comp. | 0 | ∘ | 3.31 | 8.9 | 1.47 | 3.37 | 68 | 1.15 |
| Example 4 | | | | | | | | |
| Comp. | 0.9 | x | 3.31 | 8.2 | 1.68 | 3.39 | 22.9 | 1.21 |
| Example 5 | | | | | | | | |
| Comp. | 0 | x | 3.45 | 9.4 | 1.44 | 3.45 | 81 | 1.06 |
| Example 6 | | | | | | | | |
| Example 7 | 0.9 | ∘ | 3.31 | 7.3 | 1.78 | 3.38 | 22.7 | 1.33 |
| Comp. | 0.9 | ∘ | 3.37 | 6.7 | 2.02 | 3.43 | 32.6 | 0.91 |
| Example 7 | | | | | | | | |

### (E) X-Ray Photoelectron Spectroscopy (XPS) of Negative Electrode Surface in Initial State

After the evaluation of the characteristics in the initial state, the batteries of Example 1, Comparative Example 3, and Example 6 were disassembled, and the components of the coating on the negative electrode surface were analyzed by XPS. It should be noted that for Example 1, the surfaces of the carbon layer and the lithium metal were analyzed, and that for Comparative Example 3 and Example 6, the surfaces of the lithium metal were analyzed. The XPS was conducted by using an X-ray photoelectron spectrometer (trade name: Model 5600, ULVAC-PHI Inc.). The measurement conditions are as follows.

X-ray source: Al-mono (1486.6 eV) 14 kV/200 W

Measurement diameter: 800 μmφ

Photoelectron take-off-angle: 45°

Etching conditions: acceleration voltage of 3 kV, etching rate of approximately 3.1 nm/min (based on SiO₂), raster area of 3.1 mm×3.4 mm

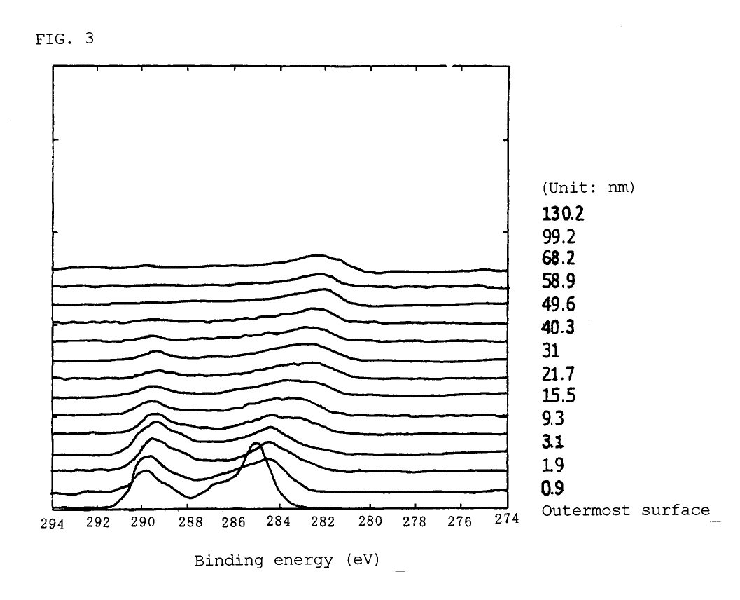

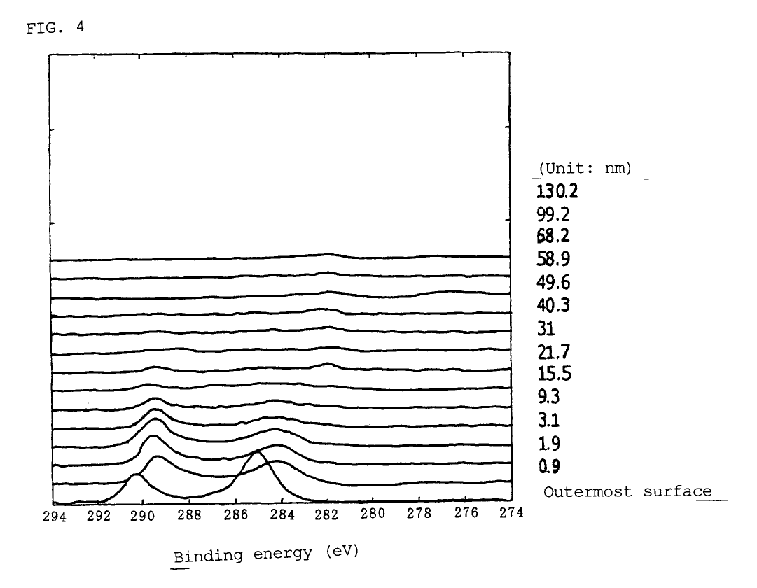

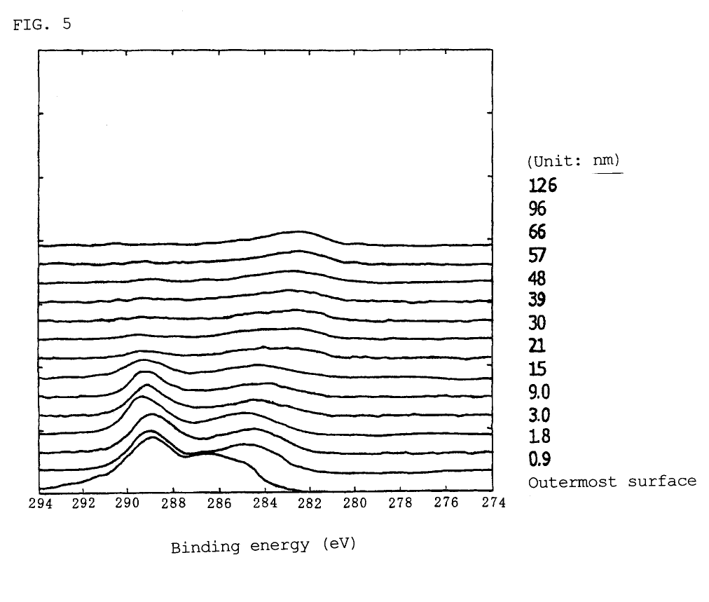

FIG. 2 shows C1s peaks in the XPS spectra of the surface of the carbon layer of Example 1. FIG. 3 shows C1s peaks in the XPS spectra of the surface of the lithium metal of Example 1. FIG. 4 shows C1s peaks in the XPS spectra of the surface of the lithium metal of Comparative Example 3. FIG. 5 shows C1s peaks in the XPS spectra of the surface of the lithium metal of Example 6.

In the C1s spectra of the surface at depths of 0.9 to 3.1 nm, the peaks around 290 to 289 eV were separated, and the ratio (area ratio) of the peak attributed to the lithium carboxylate to the peak attributed to the lithium carbonate was obtained. Table 3 shows the results.

To avoid analysis errors, data on the outermost surface was not considered. Also, although the components of the coating could be detected up to a depth of approximately 15.5 nm, the peak ratios in the range from a depth of 0.9 nm to a depth of 3.1 nm were obtained since stable detection is possible in this range of depth. At deeper depths, XPS may be inherently affected by impurities. Also, the thickness of the coating was estimated to be 3.1 nm or more and 30 nm or less.

### (F) Analysis of Carboxylic Acid Concentration in Non-Aqueous Electrolyte of Battery in Initial State

After the evaluation of the characteristics of the batteries of Examples and Comparative Examples in the initial state, the non-aqueous electrolyte was taken out from each battery, and the butyric acid concentration in the non-aqueous electrolyte was measured using a high-performance liquid chromatograph (HPLC) (Alliance available from Nihon Waters Corporation). Table 4 shows the results.

TABLE 3

| | Analyzed | |
|---|---|---|
| | depth (nm) | Peak ratio |
| Example 1 | 0.9 | 0.56 |
| | 1.9 | 0.51 |
| | 3.1 | 0.42 |
| Comp. Example 3 | 0.9 | 0.29 |
| | 1.9 | 0.26 |
| | 3.1 | 0.24 |
| Example 6 | 0.9 | 10.9 |
| | 1.8 | 19.5 |
| | 3.0 | 24.3 |

TABLE 4

| | Butyric acid concentration in |
|---|---|
| | non-aqueous electrolyte after |
| | evaluation of characteristics |
| | in initial state |
| Example 1 | Less than 0.01 wt % |
| Example 2 | Less than 0.01 wt % |
| Example 3 | Less than 0.01 wt % |
| Example 4 | Less than 0.01 wt % |
| Example 5 | Less than 0.01 wt % |
| Comp. Example 1 | Less than 0.01 wt % |
| Comp. Example 2 | Less than 0.01 wt % |
| Comp. Example 3 | Less than 0.01 wt % |
| Example 6 | Less than 0.01 wt % |
| Comp. Example 4 | Less than 0.01 wt % |
| Comp. Example 5 | Less than 0.01 wt % |
| Comp. Example 6 | Less than 0.01 wt % |
| Example 7 | Less than 0.01 wt % |
| Comp. Example 7 | 0.05 wt % |

As shown in Table 1, there was not a large difference in the OCVs in the initial state among the batteries of Examples 1 to 5 and Comparative Examples 1 to 3 using manganese dioxide as the positive electrode active material.

The batteries of Examples 1 to 5 exhibited high pulse voltages both in the initial state and after storage at 125° C., thus having good low-temperature large-current discharge characteristics.

As shown in FIG. 2, XPS confirmed that the carbon layer of Example 1 included a coating containing a lithium carboxylate and lithium carbonate. Also, an analysis of the lithium metal surface confirmed that the lithium metal surface also had almost the same coating as the carbon particle surface. It was also confirmed that the thickness of the coating was 3.1 nm or more and 30 nm or less. The thickness of the coating was estimated from the thickness in which the components of the coating were detected in XPS. It is thought that the carbon layers of Examples 2 to 5 also include a coating containing a lithium carboxylate and lithium carbonate.

Since the batteries of Examples 1 to 5 have the carbon layer including the coating, the reaction between the negative electrode and the non-aqueous electrolyte and the reaction between the carbon layer and the non-aqueous electrolyte are suppressed. Also, the carbon layer including the coating increases the reaction area of the negative electrode surface. Probably for these reasons, the increase in internal resistance was suppressed and the batteries of Examples 1 to 5 exhibited high pulse voltages.

The battery of Comparative Example 1 had a particularly high internal resistance in the initial state and low pulse voltages, compared with the batteries of Examples 1 to 5. The battery of Comparative Example 1 has a coating on the negative electrode surface, but does not have carbon particles. Probably for this reason, the reaction between the negative electrode and the non-aqueous electrolyte could not be sufficiently suppressed. Also, since carbon particles are not included, the reaction area of the negative electrode surface is small. Probably for these reasons, the resistance components on the negative electrode surface increased, thereby lowering the pulse voltage.

The battery of Comparative Example 2 had a high internal resistance in the initial state and low pulse voltages, compared with the batteries of Examples 1 to 5. This is probably because the carbon layer of Comparative Example 2 does not have a coating, and the reaction between the negative electrode and the non-aqueous electrolyte and the reaction between the carbon layer and the non-aqueous electrolyte could not be suppressed, compared with the Examples 1 to 5. Also, the battery of Comparative Example 2 exhibited a large pulse voltage drop after storage at 125° C. relative to the pulse voltage in the initial state, compared with the batteries of Examples 1 to 5. This is probably due to the following reason. During storage at 125° C., the reaction between the negative electrode and the non-aqueous electrolyte is promoted; however, since the carbon layer of Comparative Example 2 does not have a coating, the reaction between the negative electrode and the non-aqueous electrolyte cannot be sufficiently suppressed, so the internal resistance increased, thereby lowering the pulse voltage significantly.

The battery of Comparative Example 3 had a high internal resistance in the initial state and exhibited a large pulse voltage drop both in the initial state and after storage at 125° C., compared with the batteries of Examples 1 to 5. Since the battery of Comparative Example 3 does not have a carbon layer including a coating, it is thought that the reaction between the negative electrode and the non-aqueous electrolyte could not be suppressed. Also, since the battery of Comparative Example 3 does not have a carbon layer including a coating, the reaction area of the negative electrode surface is small. Probably for these reasons, the internal resistance increased, thereby lowering the pulse voltage significantly.

As shown in Table 3, in the battery of Example 1, the ratio of the peak attributed to the lithium carboxylate to the peak attributed to the lithium carbonate in the coating on the surface of the carbon particles was 0.4 or more. The batteries of Examples 2 to 5 are also believed to have a peak ratio of 0.4 or more and less than 25. A carbon layer with such a peak ratio can be obtained by bringing a carboxylic acid into contact with carbon particles. On the other hand, in the case of the battery of Comparative Example 3, in which the negative electrode does not have a carbon layer, the ratio of the peak attributed to the lithium carboxylate to the peak attributed to the lithium carbonate in the coating on the lithium metal surface was less than 0.4 (0.24 to 0.29). In the case of Comparative Example 1, although the negative electrode does not have a carbon layer, the peak ratio of the coating on the lithium metal surface is believed to be 0.4 or more and less than 25. With respect to the coating on the surface of the carbon particles of the battery of Comparative Example 2, the peak ratio is believed to be less than 0.4. As described above, in the Examples of the invention, the reaction between the negative electrode and the non-aqueous electrolyte can be sufficiently suppressed, so the pulse characteristics in a low temperature environment in the initial state and after storage at 125° C. are good. Also, in Comparative Examples 1 to 3, the reaction between the negative electrode and the non-aqueous electrolyte cannot be sufficiently suppressed.

As shown in Table 2, there was not a large difference in the OCVs in the initial state among the batteries of Examples 6 and 7 and Comparative Examples 4 to 5 using fluorinated graphite ((CF_{1.0})ₙ) as the positive electrode active material. The battery of Comparative Example 6 had a high internal resistance, compared with other batteries. The battery of Comparative Example 7 had a high voltage and a low internal resistance in the initial state, compared with other batteries.

The batteries of Examples 6 and 7 exhibited low pulse voltages in the initial state and a small pulse voltage drop after storage at 125° C. relative to the initial state, compared with the batteries of Examples 1 to 5.

In the batteries of Examples 6 and 7 and Comparative Examples 4 to 7, due to the presence of fluorine in the positive electrode, lithium fluoride (LiF) is formed on the negative electrode surface. Since lithium fluoride has an insulating property, it increases resistance. Probably for this reason, the resistance components in the initial state increased, and the pulse voltage was slightly low. On the other hand, lithium fluoride is stable even at high temperature, thereby protecting the negative electrode during high temperature storage. Probably for this reason, the pulse voltage drop after storage at 125° C. relative to the initial state was small.

The batteries of Examples 6 and 7 exhibited high pulse voltages, compared with the batteries of Comparative Examples 4 to 6, since the increase in internal resistance was suppressed both in the initial state and after storage at 125° C. Therefore, it has been found that even when fluorinated graphite is used as the positive electrode active material, the batteries with the carbon layer including the coating exhibit good low-temperature large-current discharge characteristics.

The battery of Comparative Example 4 had a high internal resistance in the initial state and low pulse voltages, compared with the batteries of Examples 6 and 7. The battery of Comparative Example 4 has a coating on the negative electrode surface, but does not have carbon particles. Probably for this reason, the reaction between the negative electrode and the non-aqueous electrolyte could not be sufficiently suppressed. Also, since carbon particles are not included, the reaction area of the negative electrode surface is small. Probably for these reasons, the resistance components on the negative electrode surface increased, thereby lowering the pulse voltage.

The battery of Comparative Example 5 had a slightly high internal resistance in the initial state and slightly low pulse voltages, compared with the batteries of Examples 6 and 7. The carbon layer of Comparative Example 5 does not have a coating. Probably for this reason, the reaction between the negative electrode and the non-aqueous electrolyte and the reaction between the carbon layer and the non-aqueous electrolyte could not be suppressed, compared with Examples 6 and 7.

The battery of Comparative Example 6 without a carbon layer including a coating had a high internal resistance in the initial state and low pulse voltages, compared with the batteries of Examples 6 and 7.

The battery of Comparative Example 7 had a low internal resistance and a high pulse characteristic in the initial state, compared with the batteries of Examples 6 and 7, but exhibited a significant deterioration in the pulse characteristic after storage at 125° C.

As shown in Table 4, in each of the batteries of Examples 1 to 7 and Comparative Examples 1 to 6, the butyric acid concentration in the non-aqueous electrolyte was less than 0.01% by weight (below the detection limit of the device). On the other hand, in the battery of Comparative Example 7, the butyric acid concentration in the non-aqueous electrolyte was 0.05% by weight. The butyric acid is a product of the reduction of the GBL contained in the non-aqueous electrolyte at the negative electrode. In Comparative Example 7, it is thought that due to the high butyric acid concentration in the non-aqueous electrolyte, excessive lithium butyrate was produced. In the initial state, an excessive coating was not formed, so the pulse characteristic was slightly improved. However, at such a high temperature as 125° C., the production of lithium butyrate is promoted. Excessive lithium butyrate makes the coating excessively dense, thereby impeding the release of ions from the surface of the lithium metal or lithium alloy and the carbon layer's function as a lithium ion release site. Probably for this reason, the pulse characteristic after 5-day storage at 125° C. deteriorated significantly.

As shown in Table 3, in the coating on the lithium metal surface of the battery of Example 6, the ratio of the peak attributed to the lithium carboxylate to the peak attributed to the lithium carbonate was 0.4 or more and less than 25. As confirmed in Example 1, it is believed that the surface of the carbon particles also had almost the same coating, i.e., a coating in which the ratio of the peak attributed to the lithium carboxylate to the peak attributed to the lithium carbonate was 0.4 or more and less than 25. In the case of the battery of Example 7, the peak ratio of the coating of the carbon layer is also believed to be 0.4 or more and less than 25. On the other hand, in the case of the battery of Comparative Example 4, the peak ratio of the coating on the lithium metal surface is believed to be 0.4 or more and less than 25, but a carbon layer is not formed. With respect to the coating of the battery of Comparative Example 5, the peak ratio is believed to be less than 0.4. In the case of the battery of Comparative Example 6, in which the negative electrode has no carbon layer, the peak ratio of the coating on the lithium metal surface is believed to be less than 0.4.

It should be noted that in the Examples, lithium metal was used as the negative electrode active material, but that the use of a lithium alloy can also produce essentially the same effects.

The lithium primary battery of the invention exhibits good large-current discharge characteristics in a low temperature environment and after high temperature storage. Therefore, it is useful as the power source for electronic devices such as portable appliances and information devices, in particular, as the main power source or memory back-up power source for in-car electronic devices.

Although the present invention has been described in terms of the presently preferred embodiments, it is to be understood that such disclosure is not to be interpreted as limiting. Various alterations and modifications will no doubt become apparent to those skilled in the art to which the present invention pertains, after having read the above disclosure. Accordingly, it is intended that the appended claims be interpreted as covering all alterations and modifications as fall within the true spirit and scope of the invention.

1. A lithium primary battery comprising:
a negative electrode comprising lithium metal or a lithium alloy;
a positive electrode including a positive electrode active material;
a separator disposed between the negative electrode and the positive electrode;
a carbon layer interposed between the negative electrode and the separator, the carbon layer comprising carbon particles and a coating on a surface of the carbon particles, the coating comprising a lithium carboxylate and lithium carbonate; and
a non-aqueous electrolyte with a carboxylic acid concentration of 0% by weight or more and less than 0.01% by weight.

2. The lithium primary battery in accordance with claim 1, wherein in an XPS spectrum of the coating, the ratio of a peak attributed to the lithium carboxylate to a peak attributed to the lithium carbonate is 0.4 or more and less than 25.

3. The lithium primary battery in accordance with claim 1, wherein the amount of the carbon particles on the surface of the negative electrode facing the positive electrode is 0.2 to 2 mg per square centimeter.

4. The lithium primary battery in accordance with claim 1, wherein the positive electrode active material comprises manganese dioxide or fluorinated graphite.

5. The lithium primary battery in accordance with claim 1, wherein the coating has a thickness of 0.9 nm or more and 30 nm or less.
